(19) United States
(12) Patent Application Publication
(10) Pub. No.: US 2004/0049990 A1
(43) Pub. Date: Mar. 18, 2004

(54) Method for producing an oxide of aluminum based corundum abrasive grain with increased tenacity and use thereof in abrasives

(76) Inventors: Franz Skale, Villach (AT); Reiner Kunz, Laufenburg (DE)

Correspondence Address: PERKINS, SMITH & COHEN LLP, ONE BEACON STREET, 30TH FLOOR, BOSTON, MA, 02108, US

(21) Appl. No.: 10/433,814

(22) PCT Filed: Nov. 30, 2001
(86) PCT No.: PCT/EP01/14027

(30) Foreign Application Priority Data
Dec. 8, 2000 (DE) 100 61 498.1

(51) Int. Cl. C09C 1/68; B24D 3/02; C09K 3/14

(52) U.S. Cl. 51/309

(57) ABSTRACT

A method for the production of an oxide of aluminum based corundum abrasive having a titanium oxide content of less than 0.8 wt. %, wherein the oxide of aluminum is processed by means of a melt or sintering process to form a compact base body for abrasive grains; the base body for abrasive grains is comminuted; the abrasive grain strip thus obtained is graded and the manufactured grain or the graded strip of abrasive grain is subsequently post-treated thermally at temperatures of 800-1500° C. in order to increase the tenacity thereof. The invention also relates to the use of the corundum abrasive grain in abrasives.

The inventions relates to a method for the production of a corundum abrasive grain in accordance with the characterizing clause of claim 1, as well as its use in abrasives on liners and/or bound abrasives.

Abrasive grains based on corundum have been known for a long time, and to this day they belong to the materials used most frequently for the treatment of surfaces or, respectively, for grinding operations. Due to the multitude of different materials to be treated, such as wood, steel, special steel, synthetics, and others, various types of corundum or, respectively, special corundum, were developed in the past that have proved their particular mettle in certain cases of use.

For example, normal and semi-precious corundum obtained directly from bauxite via a reducing melt in an electric arc that, in addition to Al₂O₃, also contains portions of TiO₂ in the end product, is characterized by an increased toughness as compared with precious corundum melted from alum earth in an electric arc that consists almost exclusively of aluminum oxide, and they are preferably used in bound abrasives in the treatment of metals, metal alloys, cast and regular steel. These corundum types in abrasives on a liner are also used for treating metals and alloys, but wood and synthetics, too. The toughness of the titanium-containing corundum can be increased even more through additional heat treatment under oxidizing conditions during which the titanium suboxide (Ti₂O₃) is oxidized on the grain surface and titanium-aluminum compounds with tetravalent titanium are formed. Defects in the ionic lattice cause a blue coloration on the surface of the titanium-containing abrasive grains following the heat treatment. The increase in toughness is mainly attributed to the presence of titanium as an alloy component.

Even tougher corundum abrasive grains can be obtained, for example, by alloying Al₂O₃ with ZrO₂, with the zircon oxide being melted together with the aluminum oxide and the liquid melt then being quenched as quickly as possible in order to prevent a segregation of the components during the cooling phase. Through this process an abrasive with microcrystalline structure is formed in which ZrO₂ and Al₂O₃ are present side by side in a homogeneous distribution. The production of zircon corundum is described in EP-B-0 595 081, for example.

Materials of similar toughness and also with a microcrystalline structure can be obtained via a chemical or, respectively, ceramic route as well, during which a starting material of superfine alum earth or a corresponding pre-material from which Al₂O₃ is formed during the production process is processed into a green body which is then sintered at temperatures between 1200 and 1600° C. Sinter corundum is described in EP-B-0 152 068 and EP-A-0 725 045, for example.

The precious corundum melted from alum earth, on the other hand, is more brittle and, due to the high cutting force connected therewith, is therefore used advantageously for the treatment of wood, nonferrous metals, leather, synthetics, rubber and lacquers. In addition to the pure precious corundum which consists of 99.8% Al₂O₃, others have been known that show minor additional portions of alloy components such as Cr₂O₃, TiO₂ and others, but also mixtures thereof, which partially increases the toughness of the precious corundum. The toughness values of those materials lie between those of the pure precious corundum and those of the regular and semi-precious corundum melted from bauxite. In addition to those, other corundum types have been known whose toughness also lies within this range. An example thereof is the so-called single-crystal corundum that is obtained from the melt through deliberate crystallization during cooling and that can be used advantageously during precision grinding, for example. In an ideal case, the single-crystal corundum involves a block-like abrasive grain with perfect cutting edges that grew in the melt into its corresponding shape and size and that can be processed following the cooling of the melt without any extensive comminution work.

Due to the enormous variety of the various materials, surfaces and shapes that are to be treated as well as to the various requirements of the treatment process itself, all of the corundum types mentioned above are not only used preferably for certain grinding operations, but there continues to exist a need for using, for special grinding operations, corundum types with certain properties that lie between those of the types listed above or that exceed those of the types listed above. It is partially possible to meet that need by resorting to the use of mixtures of the various types in order to achieve a very specific grinding behavior of the abrasive for certain grinding operations.

Thus, in general, in the treatment of surfaces by means of abrasives one can see the trend towards adapting the abrasive to the material to be treated to an even greater degree in order to further improve, for example, the abrasion performance or the surface quality. Depending on the type of the abrasive to be considered, the abrasive manufacturer has various options at his disposal in order to achieve an additional optimization.

For example, in the production of so-called abrasives on a liner (grinding belts, abrasive paper, etc.) one can, in addition to the abrasive grain itself, adapt and optimize the carrier for the abrasive grain (the liner); the binder that affixes the abrasive grain to the liner; and the so-called abrasion auxiliary materials (chemical compounds that intervene in the grinding process). In the production of bound abrasives (abrasive disks, abrasive wheels, and others) there is also an opportunity to adapt the binding, the abrasive auxiliary materials (abrasion-active substances), the fillers and, of course, the abrasive grain itself to each other and to optimize them for a certain abrasion process.

Even though the right recipe for the binding, other raw materials and production conditions is of quite decisive importance for a successful use as an abrasive, in the final analysis it is the proper abrasive grain which after all does the actual abrasion work (material abrasion) that is the decisive criterion for an efficient and successful use of the abrasive.

Therefore it is the objective of the invention to make available a method for the production of a corundum abrasive grain that features an improved property profile in comparison with the abrasive grains according to the state of the art, which makes an even better adaptation of the abrasive to certain grinding operations possible and which allows a corresponding higher abrasion performance.

This task is solved by a method for the production of a corundum abrasive grain on the basis of alum earth with a titanium oxide contents of less than 0.8 wt. %, with

a) alum earth being processed into a compact base body for abrasive grains by way of a melting or sintering process

b) the base body for abrasive grains being comminuted,

c) the abrasive grain strip obtained thereby being graded by way of sifting,

d) the finished abrasive grain or the graded abrasive strip subsequently being subjected to a thermal treatment between 800 and 1500° C. to increase its toughness.

Surprisingly it was discovered that by way of subsequent thermal treatment an improvement of the physical properties that are responsible for the abrasion performance (such as toughness) can also be achieved for corundum types that contain no or very little titanium oxide, and that corundum types can thus be obtained without any great expenditures whose properties expressly differ from the known corundum types and which therefore offer advantages for certain grinding operations as compared to the materials utilized so far. This improvement can also be observed in corundum types that contain additional oxidic alloy components from the group of Cr₂O₃, MgO, NiO, ZnO, CoO, ZrO₂, TiO₂, SiO₂, and/or oxides of the rare earths, in addition to Al₂O₃.

The subsequent thermal treatment occurs at temperatures between 800 and 1500° C., preferably between 900 and 1300° C. Cylindrical rotary furnaces or oscillating furnaces are particularly well suited as aggregates for the subsequent thermal treatment; but in principle any furnace type known and suitable in the manufacture of ceramics, such as, e.g., a sliding bat kiln or a chamber furnace, may be used. A particularly uniform treatment can be preferably achieved in a fluidized-bed sintering furnace. The treatment time (sojourn time in the furnace) usually lies between 15 and 120 minutes.

An already sifted granulate or at least a relatively narrow grain band is used as starting material for the subsequent thermal treatment in order to guarantee the best-possible homogeneous and uniform treatment and treatment length. Following the treatment it is recommended to perform an additional protective sifting in order to separate or destroy any aggregates that may have formed.

A dependence of product quality on the length and temperature of the treatment could be observed. For example, at temperatures of up to 1500° C. and sojourn times of up to 120 minutes, it was possible to observe in general an increase of the product quality with increasing temperature and duration of the treatment. However, the essential increase in product quality was reached at temperatures between 1000 and 1200° C., which for practical and economic reasons led to the examples listed below being carried out exclusively at temperatures of 1200° C. and a treatment time of 30 minutes.

Grain toughness and abrasion performance during the grinding test were used for an evaluation of the properties of the abrasive grain.

One option for the determination of the wear-and-tear properties (toughness) of an abrasive grain is the so-called Battelle Test prepared in 1962 (Regulations of June 1962) by the Frankfurt Battelle Institute E.V. on behalf of the Verband Deutscher Schleifmittelwerke e.V. [Association of German Abrasive Manufacturers] to determine grain toughness in which a certain amount of a narrowly graded grain fraction is ground in a ball crusher of certain dimensions under precisely established conditions. After certain grinding intervals the portion of the destroyed abrasive grain is determined by way of a test sifting. The increase of the destroyed grain amount is shown graphically as a function of the grinding time, and this way one determines the grinding time—expressed as the number of mill revolutions—required to destroy one third of the test amount. The decimal logarithm of this number is the toughness value that is being looked for.

In this process, the sieves and sifting aggregates prescribed under the PEPA standard are used for the sifting of the test grains. A cylindrical steel container with an interior length of 145±2 mm and an interior diameter of 145±2 mm is used as grinding vessel that is filled with hardened ball-bearing balls made of chromium steel with a Rockwell hardness of approximately 63, using 8 balls with a nominal diameter of 35 mm and a minimum of 40 and a maximum of 45 balls with a nominal diameter of 15 mm.

For the measurement, the grinding vessel is filled with a specified amount (31.5×specific gravity) of test material and, lying horizontally on a roller block, set into a revolving motion at an RPM of 83±1. Following a specified number of mill revolutions (e.g. 200, 400, 800, etc.) the portion of undestroyed grain fraction is determined. The measurements are repeated until more than one third of the grain fraction has been destroyed.

Prerequisite for a valid comparison of the toughness values of various abrasive grains determined in this fashion is the fact that the test material be of the same grain size and comparable settled density. The Battelle method is particularly well suited for coarse granulates.

For the determination of the grain toughness of finer granulates a related method may be used by way of the so-called splinter test which concerns an internal method of the registrant based on the same principle as the Battelle test in which again a specified amount of sifted grains is used which, however, is not treated in a ball crusher but is hurled against a metal plate under preset conditions (pressure) by means of compressed air. Subsequently the amount of undestroyed grain fraction is determined in the same way as in the Battelle test. The difference with the starting value yields the splinter value in %.

During the toughness tests it was determined that on average an increase in toughness of approximately 10% was achieved, measured according to Battelle, while in the case the finer granulates, due to the difference in the measuring methods, increases in toughness (reduction of the splinter value) of up to 70% could be determined. By way of parallel grinding tests, an increase in the abrasion performance in a magnitude of approximately 10% to approximately 30% could be recorded.

The abrasion performances were tested in various grinding operations which are shown more detailed in the examples below and by means of which the invention at hand is explained further, without this constituting any limitation.

### EXAMPLE 1

The corundum types listed in Table 1 having a FEPA granulation of F24 were subjected to a subsequent thermal treatment at 1200° C. in a cylindrical rotary kiln. The sojourn time in the furnace amounted to 30 minutes.

TABLE 1
Grain toughness of various corundum types in F24
granulation before and after thermal treatment

| | | Grain Toughness | |
|---|---|---|---|
| | | (lgz) | |
| Abrasive Grain (F24) | Settled Density (g/l) | before | after |
| Microcrystalline sinter | 1686 | 2.64 | 2.87 |
| corundum | | | |
| Precious corundum White | 1721 | 2.46 | 2.74 |
| Precious corundum Pink | 1730 | 2.53 | 2.78 |
| Precious corundum Dark | 1750 | 2.57 | 2.83 |
| Red | | | |
| Single-crystal corundum | 1853 | 2.68 | 2.94 |

### EXAMPLE 2

The corundum types listed in Table 2 having a FEPA granulation of F80 were subjected to a subsequent thermal treatment at 1200° C. in a cylindrical rotary kiln. The sojourn time in the furnace amounted to 30 minutes.

TABLE 2
Grain toughness of various corundum types in
F80 granulation before and after thermal treatment

| | | Grain Toughness | |
|---|---|---|---|
| | | (Splinter Value) | |
| Abrasive Grain (F80) | Settled Density (g/l) | before | after |
| Microcrystalline sinter | 1756 | 12.1% | 6.8% |
| corundum | | | |
| Precious corundum White | 1834 | 14.6% | 10.4% |
| Precious corundum Pink | 1865 | 13.8% | 11.5% |
| Precious corundum Dark | 1828 | 14.1% | 12.6% |
| Red | | | |
| Single-crystal corundum | 1930 | 9.7% | 7.4% |

### EXAMPLE 3

The corundum types listed in Table 3 having a FEPA granulation of F120 were subjected to a subsequent thermal treatment at 1200° C. in a cylindrical rotary kiln. The sojourn time in the furnace amounted to 30 minutes.

TABLE 3
Grain toughness of various corundum types in F120 granulation

| | | Grain Toughness | |
|---|---|---|---|
| | | (Splinter Value) | |
| Abrasive Grain (F120) | Settled Density (g/l) | before | after |
| Microcrystalline sinter | 1765 | 13.4% | 9.2% |
| corundum | | | |
| Precious corundum White | 1834 | 17.6% | 14.2% |
| Precious corundum Pink | 1856 | 14.3% | 12.8% |
| Precious corundum Dark | 1898 | 15.6% | 14.1% |
| Red | | | |
| Single-crystal corundum | 1720 | 12.2% | 8.7% |

### EXAMPLE 4

### Grinding Test I

The corundum granulations from Example 1 were processed into a ceramically bound grinding disk with a 230×4.5×51 (dimension) specification and an A24K8V40 binding. The disk was used for plunge-cut grinding of hardened steel K 110=DIN 1.2379=X 155 CrVMn 12 1 (HRc=65) with an advance of 40 μm and a feed speed of 19 m/min. The abrasion performances that were achieved (G factor=quotient of abrasion amount and disk wear) are shown in Table 4.

TABLE 4
Grinding test (plunge-cut grinding)

| | | G Factor | |
|---|---|---|---|
| Abrasive Grain (F24) | Settled Density (g/l) | before | after |
| Microcrystalline sinter | 1686 | 17.5 | 18.2 |
| corundum | | | |
| Precious corundum White | 1721 | 10.3 | 12.1 |
| Precious corundum Pink | 1730 | 10.4 | 12.1 |
| Precious corundum Dark | 1750 | 11.2 | 12.7 |
| Red | | | |
| Single-crystal corundum | 1853 | 14.3 | 16.9 |

### EXAMPLE 5

### Grinding Test II

The corundum granulations from Example 2 were processed into a ceramically bound grinding disk with a 245×15×51 (dimension) specification and an A80K8V40 binding. The disk was used for surface grinding of hardened steel S 600=DIN 1.3343=S 6−5−2 with an advance of 20 μm and a feed speed of 35 m/s. The abrasion performances that were achieved (G factor=quotient of abrasion amount and disk wear) are shown in Table 5.

TABLE 5
Grinding test (surface grinding)

| | | G Factor | |
|---|---|---|---|
| Abrasive Grain (F80) | Settled Density (g/l) | before | after |
| Microcrystalline sinter corundum | 1756 | 29 | 34 |
| Precious corundum White | 1834 | 15 | 18 |
| Precious corundum Pink | 1865 | 14 | 16 |
| Precious corundum Dark Red | 1828 | 16 | 20 |
| Single-crystal corundum | 1930 | 22 | 28 |

### EXAMPLE 4

### Grinding Test III

The corundum granulations from Example 3 were processed into a ceramically bound grinding disk with a 245×15×51 (dimension) specification and an A120G13V40 binding. The disk was used for surface grinding of hardened steel K 110−DIN 1.3343=S 6−5−2 with an advance of 15 μm and a feed speed of 19 m/min. The abrasion performances that were achieved (G factor=quotient of abrasion amount and disk wear) are shown in Table 6.

TABLE 6
Grinding test (surface grinding)

| | | G Factor | |
|---|---|---|---|
| Abrasive Grain (F24) | Settled Density (g/l) | before | after |
| Microcrystalline sinter corundum | 1765 | 12.3 | 15.7 |
| Precious corundum White | 1834 | 6.2 | 7.4 |
| Precious corundum Pink | 1856 | 5.8 | 6.5 |
| Precious corundum Dark Red | 1898 | 6.0 | 6.7 |
| Single-crystal corundum | 1720 | 10.3 | 11.8 |

1. Method for the production of a corundum abrasive grain on the basis of alum earth with a titanium oxide contents of less than 0.8 wt. % during which
a) alum earth is processed into a compact base body for abrasive grains through a melting and sintering process,
b) the base body for abrasive grains is comminuted, and
c) the abrasive grain strip obtained in this fashion is graded by way of sifting,
characterized by the fact that the finished abrasive granulation of the graded abrasive grain strip is subjected to a subsequent thermal treatment between 800 and 1500° C. to increase its toughness.

2. Method for the production of a corundum abrasive grain in accordance with claim 1 characterized by the fact that the subsequent thermal treatment is carried out between 900 and 1300° C.

3. Method for the production of a corundum abrasive grain in accordance with one or several of claims 1 and 2 characterized by the fact that the time for the subsequent thermal treatment lies between 15 and 120 minutes, preferably between 20 and 60 minutes.

4. Method for the production of a corundum abrasive grain in accordance with one or several of claims 1 through 3 characterized by the fact that the subsequent thermal treatment is carried out in a cylindrical rotary kiln, a to-and-fro kiln, a chamber oven or a tunnel furnace.

5. Method for the production of a corundum abrasive grain in accordance with one or several of claims 1 through 4 characterized by the fact that the subsequent thermal treatment is carried out in a fluid-bed sintering furnace.

6. Method for the production of a corundum abrasive grain in accordance with one or several of claims 1 through 5 characterized by the fact that other oxidic alloy components from the group of Cr₂O₃, MgO, NiO, ZnO, CoO, ZrO₂, TiO₂, SiO₂, and/or oxides of the rare earths are used in addition to the alum earth.

7. Method for the production of a corundum abrasive grain in accordance with one or several of claims 1 through 6 characterized by the fact that the contents of oxidic alloy components from the group of Cr₂O₃, MgO, NiO, ZnO, CoO, ZrO₂, TiO₂, SiO₂, and/or oxides of the rare earths does not amount to more than 5 wt. %, with the contents of TiO₂ alone not exceeding 0.8 wt. %.

8. Use of a corundum abrasive grain produced in accordance with a method according to one or several of claims 1 through 7 on a lining and/or in bound abrasives.
